(19) United States
(12) Patent Application Publication
(10) Pub. No.: US 2014/0006243 A1
(43) Pub. Date: Jan. 2, 2014

(54) Multiple Trade Matching Algorithms

(71) Applicants: James Boudreault, Palatine, IL (US); Frederick Storm, Chicago, IL (US); John Labuszewski, Westmont, IL (US); Daniel Grombacher, Evanston, IL (US); Jonathan Kronstein, Elmhurst, IL (US); Peter Barker, Chicago, IL (US); Suzanne Spain, Chicago, IL (US)

(72) Inventors: James Boudreault, Palatine, IL (US); Frederick Storm, Chicago, IL (US); John Labuszewski, Westmont, IL (US); Daniel Grombacher, Evanston, IL (US); Jonathan Kronstein, Elmhurst, IL (US); Peter Barker, Chicago, IL (US); Suzanne Spain, Chicago, IL (US)

(21) Appl. No.: 13/534,399

(22) Filed: Jun. 27, 2012

(51) Int. Cl. G06Q 40/04

(52) U.S. Cl. 705/37

(57) ABSTRACT

The disclosed embodiments relate to systems and methods which match/allocate an incoming order to trade with “resting,” i.e. previously received but not yet matched, orders, recognizing that the algorithm or rules by which the incoming order is matched may affect the operation of the market for the financial product being traded. In particular, the disclosed embodiments relate to an adaptive match engine which draws upon different matching algorithms, e.g. the rules which dictate how a given order should be allocated among qualifying resting orders, depending upon market conditions, to improve the operation of the market. Thereby, by conditionally switching among matching algorithms within the same financial product, as will be described, the disclosed match engine automatically adapts to the changing market conditions of a financial product, e.g. a limited life product, in a non-preferential manner, maintaining fair order allocation while improving market liquidity, e.g., over the life of the product.

### BACKGROUND

A financial instrument trading system, such as a futures exchange, referred to herein also as an “Exchange”, such as the Chicago Mercantile Exchange Inc. (CME), provides a contract market where financial products/instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time, referred to as the expiration date or expiration month. An option is the right, but not the obligation, to sell or buy the underlying instrument (in this case, a futures contract) at a specified price within a specified time. The commodity to be delivered in fulfillment of the contract, or alternatively, the commodity, or other instrument/asset, for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract price.

Typically, the Exchange provides for a centralized “clearing house” through which all trades made must be confirmed, matched, and settled each day until offset or delivered. The clearing house is an adjunct to the Exchange, and may be an operating division thereof, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Current financial instrument trading systems allow traders to submit orders and receive confirmations, market data, and other information electronically via a network. These “electronic” marketplaces have largely supplanted the pit based trading systems whereby the traders, or their representatives, all physically stand in a designated location, i.e. a trading pit, and trade with each other via oral and hand based communication. In contrast to the pit based trading system where like-minded buyers and sellers can readily find each other to trade, electronic marketplaces must electronically “match” the orders placed by buyers and sellers on behalf thereof. Electronic trading systems may offer a more efficient and transparent system of trading. For example, in pit trading, subjective elements and limits on human interaction may unduly influence the process by which buyers and sellers come together to trade or otherwise limit the trading opportunities, limiting market liquidity. In contrast, an electronic exchange may be more objective when matching up a buyer and seller, relying solely on objective factors such as price and time of order placement, etc. As such, electronic trading systems may achieve more fair and equitable matching among traders as well as identify more opportunities to trade, thereby improving market liquidity.

### BRIEF DESCRIPTION OF THE DRAWINGS

FIG. 1 depicts an illustrative computer network system that may be used to implement aspects of the disclosed embodiments.

FIG. 2 a block diagram of an exemplary implementation of the system of FIG. 1 for managing communications of financial messages.

FIG. 3 depicts a flow chart showing operation of the system of FIGS. 1 and 2.

FIG. 4 shows an illustrative embodiment of a general computer system for use with the system of FIGS. 1 and 2.

FIGS. 5A-5B depicts general application of the system of FIG. 2 based on time to contract expiration, according to one embodiment.

FIGS. 6A-6B depict an alternate application of the system of FIG. 2 based on time to contract expiration, according to one embodiment.

FIGS. 7A-7B depict an alternate application of the system of FIG. 2 based on various market factors, according to one embodiment.

### DETAILED DESCRIPTION

The disclosed embodiments relate to systems and methods which match or otherwise allocate an incoming order to trade with “resting,” i.e. previously received but not yet matched, orders, recognizing that the algorithm or rules by which the incoming order is matched/allocated may affect the operation of the market for the financial product being traded. In particular, the disclosed embodiments relate to an adaptive match engine which draws upon different matching algorithms, e.g. the rules which dictate how a given order should be allocated among qualifying resting orders, depending upon market conditions, to improve the operation of the market. For example, for a financial product, such as a futures contract, having a future expiration date, the match engine may match incoming orders according to one algorithm when the remaining time to expiration is above a threshold, recognizing that during this portion of the life of the contract, the market for this product is likely to have high volatility. However, as the remaining time to expiration decreases, volatility may decrease. Accordingly, when the remaining time to expiration falls below the threshold, the match engine switches to a different match algorithm which may be designed to encourage trading relative to the declining trading volatility. Thereby, by conditionally switching among matching algorithms within the same financial product, as will be described, the disclosed match engine automatically adapts to the changing market conditions of a financial product, e.g. a limited life product, in a non-preferential manner, maintaining fair order allocation while improving market liquidity, e.g., over the life of the product.

In one implementation, a trading system may evaluate market conditions on a daily basis and, based thereon, change the matching algorithm between daily trading sessions, i.e. when the market is closed, such that when the market reopens, a new trading algorithm is in effect for the particular product. As will be described, the disclosed embodiments may facilitate more frequent changes to the matching algorithms so as to dynamically adapt to changing market conditions, e.g. intra-day changes, and even intra-order matching changes. It will be further appreciated that hybrid matching algorithms, which match part of an order using one algorithm and another part of the order using a different algorithm, may also be used.

While the disclosed embodiments may be discussed in relation to futures and/or options on futures trading, it will be appreciated that they may be applicable to any equity, options or futures trading system, e.g., exchange, Electronic Communication Network (“ECN”), Alternative Trading System (“ATS”), or Swap Execution Facility (“SEF”), or market now available or later developed, e.g. cash, Futures, etc., as well as any instrument traded thereon. It will be appreciated that a trading environment, such as a futures exchange as described herein, implements one or more economic markets where rights and obligations may be traded. As such, a trading environment may be characterized by a need to maintain market integrity, transparency, predictability, fair/equitable access and participant expectations with respect thereto. For example, an exchange must respond to inputs, such as trade orders, cancellation, etc., in a manner as expected by the market participants, such as based on market data, e.g. prices, available counter-orders, etc., to provide an expected level of certainty that transactions will occur in a consistent and predictable manner and without unknown or unascertainable risks. In addition, it will be appreciated that electronic trading systems further impose additional expectations and demands by market participants as to transaction processing speed, latency, capacity and response time, while creating additional complexities relating thereto. Accordingly, as will be described, the disclosed embodiments may further include functionality to ensure that the expectations of market participant are met, e.g. that transactional integrity and predictable system responses are maintained.

As was discussed above, electronic trading systems ideally attempt to offer an objective, efficient, fair and balanced market where market prices reflect a true consensus of the value of products traded among the market participants, where the intentional or unintentional influence of human interaction is minimized if not eliminated, and where unfair or inequitable advantages with respect to information access are minimized if not eliminated.

Further, as discussed above, an exchange provides one or more markets for the purchase and sale of various types of products including financial instruments such as stocks, bonds, futures contracts, options, currency, cash, and other similar instruments. Agricultural products and commodities are also examples of products traded on such exchanges. A futures contract is a product that is a contract for the future delivery of another financial instrument such as a quantity of grains, metals, oils, bonds, currency, or cash. Generally, each exchange establishes a specification for each market provided thereby that defines at least the product traded in the market, minimum quantities that must be traded, and minimum changes in price (e.g., tick size). For some types of products (e.g., futures or options), the specification further defines a quantity of the underlying product represented by one unit (or lot) of the product, and delivery and expiration dates. As will be described, the Exchange may further define the matching algorithm, or rules, by which incoming orders will be matched/allocated to resting orders.

Some products on an exchange are traded in an open outcry environment where the exchange provides a location for buyers and sellers to meet and negotiate a price for a quantity of a product. Other products are traded on an electronic trading platform (e.g., an electronic exchange), also referred to herein as a trading platform, trading host or Exchange Computer System, where market participants, e.g. traders, use software to send orders to the trading platform. The order identifies the product, the quantity of the product the trader wishes to trade, a price at which the trader wishes to trade the product, and a direction of the order (i.e., whether the order is a bid, i.e. an offer to buy, or an ask, i.e. an offer to sell).

The Exchange Computer System, as will be described below, monitors incoming orders received thereby and attempts to identify, i.e., match or allocate, as will be described in more detail below, one or more previously received, but not yet matched, orders, i.e. limit orders to buy or sell a given quantity at a give price, referred to as “resting” orders, stored in an order book database, wherein each identified order is contra to the incoming order and has a favorable price relative to the incoming order. An incoming order may be an “aggressor” order, i.e., a market order to sell a given quantity at whatever may be the resting bid order price(s) or a market order to buy a given quantity at whatever may be the resting ask order price(s). In particular, if the incoming order is a bid, i.e. an offer to buy, then the identified order(s) will be an ask, i.e. an offer to sell, at a price that is identical to or higher than the bid price. Similarly, if the incoming order is an ask, i.e. an offer to sell, the identified order(s) will be a bid, i.e. an offer to buy, at a price that is identical to or lower than the offer price.

Upon identification (matching) of a contra order(s), a minimum of the quantities associated with the identified order and the incoming order is matched and that quantity of each of the identified and incoming orders become two halves of a matched trade that is sent to a clearinghouse. The Exchange Computer System considers each identified order in this manner until either all of the identified orders have been considered or all of the quantity associated with the incoming order has been matched, i.e. the order has been filled. If any quantity of the incoming order remains, an entry may be created in the order book database and information regarding the incoming order is recorded therein, i.e. a resting order is placed on the order book for the remaining quantity to await a subsequent incoming order counter thereto.

Traders access the markets on a trading platform using trading software that receives and displays at least a portion of the order book for a market, i.e. at least a portion of the currently resting orders, enables a trader to provide parameters for an order for the product traded in the market, and transmits the order to the Exchange Computer System. The trading software typically includes a graphical user interface to display at least a price and quantity of some of the entries in the order book associated with the market. The number of entries of the order book displayed is generally preconfigured by the trading software, limited by the Exchange Computer System, or customized by the user. Some graphical user interfaces display order books of multiple markets of one or more trading platforms. The trader may be an individual who trades on his/her behalf, a broker trading on behalf of another person or entity, a group, or an entity. Furthermore, the trader may be a system that automatically generates and submits orders.

If the Exchange Computer System identifies that an incoming market order may be filled by a combination of multiple resting orders, e.g. the resting order at the best price does only partially fills the incoming order, the Exchange Computer System may allocate the remaining quantity of the incoming, i.e. that which was not filled by the resting order at the best price, among such identified orders in accordance with prioritization and allocation rules/algorithms, referred to as “matching algorithms,” as, for example, may be defined in the specification of the particular financial product or defined by the Exchange for multiple financial products. Similarly, if the Exchange Computer System identifies multiple orders contra to the incoming limit order and that have an identical price which is favorable to the price of the incoming order, i.e. the price is equal to or better, e.g. lower if the incoming order is a buy or higher if the incoming order is a sell, than the price of the incoming order, the Exchange Computer System may allocate the quantity of the incoming order among such identified orders in accordance with the matching algorithms as, for example, may be defined in the specification of the particular financial product or defined by the Exchange for multiple financial products.

As was noted above, an Exchange must respond to inputs, such as trader orders, cancellation, etc., in a manner as expected by the market participants, such as based on market data, e.g. prices, available counter-orders, etc., to provide an expected level of certainty that transactions will occur in a consistent and predictable manner and without unknown or unascertainable risks. Accordingly, the method by which incoming orders are matched with resting orders must be defined so that Traders know what the expected result will be when they place an order or have resting orders and incoming order is received. Typically, the Exchange defines the matching algorithm that will be used for a particular financial product, with or without input from the market participants. Once defined for a particular product, the matching algorithm is typically not altered, except in limited circumstance, such as to correct errors or improve operation, so as not to disrupt trader expectations. It will be appreciated that different products offered by a particular Exchange may use different matching algorithms.

For example, a first-in/first-out (FIFO) matching algorithm, also referred to as a “Price Time” algorithm, considers each identified order sequentially in accordance with when the identified order was received. The quantity of the incoming order is matched to the quantity of the identified order received earliest, then quantities of the next earliest, and so on until the quantity of the incoming order is exhausted. Some product specifications define the use of a pro-rata matching algorithm, wherein a quantity of an incoming order is allocated to each of plurality of identified orders proportionally. Some Exchange Computer Systems provide a priority to certain standing orders in particular markets. An example of such an order is the first order that improves a price (i.e., improves the market) for the product during a trading session. To be given priority, the trading platform may require that the quantity associated with the order is at least a minimum quantity. Further, some Exchange Computer Systems cap the quantity of an incoming order that is allocated to a standing order on the basis of a priority for certain markets. In addition, some Exchange Computer Systems may give a preference to orders submitted by a trader who is designated as a market maker for the product. Other Exchange Computer Systems may use other criteria to determine whether orders submitted by a particular trader are given a preference. Typically, when the Exchange Computer System allocates a quantity of an incoming order to a plurality of identified orders at the same price, the trading host allocates a quantity of the incoming order to any orders that have been given priority. The Exchange Computer System thereafter allocates any remaining quantity of the incoming order to orders submitted by traders designated to have a preference, and then allocates any still remaining quantity of the incoming order using the FIFO or pro-rata algorithms. Pro-rata algorithms used in some markets may require that an allocation provided to a particular order in accordance with the pro-rata algorithm must meet at least a minimum allocation quantity. Any orders that do not meet or exceed the minimum allocation quantity are allocated to on a FIFO basis after the pro-rata allocation (if any quantity of the incoming order remains). More information regarding order allocation may be found in U.S. Pat. No. 7,853,499, the entirety of which is incorporated by reference herein.

Other examples of matching algorithms which may be defined for allocation of orders of a particular financial product include:
Price Explicit Time
Order Level Pro Rata
Order Level Priority Pro Rata
Preference Price Explicit Time
Preference Order Level Pro Rata
Preference Order Level Priority Pro Rata
Threshold Pro-Rata
Priority Threshold Pro-Rata
Preference Threshold Pro-Rata
Priority Preference Threshold Pro-Rata
Split Price-Time Pro-Rata
For example, the Price Explicit Time trading policy is based on the basic Price Time trading policy with Explicit Orders having priority over Implied Orders at the same price level. The order of traded volume allocation at a single price level may therefore be:
Explicit order with oldest timestamp first. Followed by
Any remaining explicit orders in timestamp sequence (First In, First Out—FIFO) next. Followed by
Implied order with oldest timestamp next. Followed by
Any remaining implied orders in timestamp sequence (FIFO).

In Order Level Pro Rata, also referred to as Price Pro Rata, priority is given to orders at the best price (highest for a bid, lowest for an offer). If there are several orders at this best price, equal priority is given to every order at this price and incoming business is divided among these orders in proportion to their order size. The Pro Rata sequence of events is:
1. Extract all potential matching orders at best price from the order book into a list.
2. Sort the list by order size, largest order size first. If equal order sizes, oldest timestamp first. This is the matching list.
3. Find the ‘Matching order size, which is the total size of all the orders in the matching list.
4. Find the ‘tradable volume’, which is the smallest of the matching volume and the volume left to trade on the incoming order.
5. Allocate volume to each order in the matching list in turn, starting at the beginning of the list. If all the tradable volume gets used up, orders near the end of the list may not get allocation.
6. The amount of volume to allocate to each order is given by the formula:

(Order volume/Matching volume)*Tradable volume
The result is rounded down (for example, 21.99999999 becomes 21) unless the result is less than 1, when it becomes 1.
7. If tradable volume remains when the last order in the list had been allocated to, return to step 3.
   Note: The matching list is not re-sorted, even though the volume has changed. The order which originally had the largest volume is still at the beginning of the list.
8. If there is still volume left to trade on the incoming order, repeat the entire algorithm at the next price level.

Order Level Priority Pro Rata, also referred to as Threshold Pro Rata, is similar to the Price (or ‘Vanilla’) Pro Rata algorithm but has a volume threshold defined. Any pro rata allocation below the threshold will be rounded down to 0. The initial pass of volume allocation is carried out in using pro rata; the second pass of volume allocation is carried out using Price Explicit Time. The Threshold Pro Rata sequence of events is:
1. Extract all potential matching orders at best price from the order book into a list.
2. Sort the list by explicit time priority, oldest timestamp first. This is the matching list.
3. Find the ‘Matching volume’, which is the total volume of all the orders in the matching list.
4. Find the ‘tradable volume’, which is the smallest of the matching volume and the volume left to trade on the incoming order.
5. Allocate volume to each order in the matching list in turn, starting at the beginning of the list.
6. The amount of volume to allocate to each order is given by the formula:

(Order volume/Matching volume)*Tradable volume
The result is rounded down to the nearest lot (for example, 21.99999999 becomes 21) unless the result is less than the defined threshold in which case it is rounded down to 0.
7. If tradable volume remains when the last order in the list had been allocated to, the remaining volume is allocated in time priority to the matching list.
8. If there is still volume left to trade on the incoming order, repeat the entire algorithm at the next price level.

In the Split Price Time Pro-Rata algorithms, a Price Time Percentage parameter is defined. This percentage of the matching volume at each price is allocated by the Price Explicit Time algorithm and the remainder is allocated by the Threshold Pro-Rata algorithm. There are four variants of this algorithm, with and without Priority and/or Preference. The Price Time Percentage parameter is an integer between 1 and 99. (A percentage of zero would be equivalent to using the respective existing Threshold Pro-Rata algorithm, and a percentage of 100 would be equivalent to using the respective existing Price Time algorithm). The Price Time Volume will be the residual incoming volume, after any priority and/or Preference allocation has been made, multiplied by the Price Time Percentage. Fractional parts will be rounded up, so the Price Time Volume will always be at least 1 lot and may be the entire incoming volume. The Price Time Volume is allocated to resting orders in strict time priority. Any remaining incoming volume after the Price Time Volume has been allocated will be allocated according to the respective Threshold Pro-Rata algorithm. The sequence of allocation, at each price level, is therefore:
1. Priority order. if applicable
2. Preference allocation, if applicable
3. Price Time allocation of the configured percentage of incoming volume
4. Threshold Pro-Rata allocation of any remaining incoming volume
5. Final allocation of any leftover lots in time sequence.
   Any resting order may receive multiple allocations from the various stages of the algorithm.

It will be appreciated that there may be other allocation algorithms, including combinations of algorithms, now available or later developed, which may be utilized with the disclosed embodiments, and all such algorithms are contemplated herein.

Prior matching systems apply a single algorithm, or combined algorithm, to all of the orders received for a particular financial product to dictate how the entire quantity of the incoming order is to be matched/allocated. In contrast, the disclosed embodiments may apply different matching algorithms, singular or combined, to different orders, as will be described, recognizing that the allocation algorithms used by the trading host for a particular market may, for example, affect the liquidity of the market. Specifically, some allocation algorithms may encourage traders to submit more orders, where each order is relatively small, while other allocation algorithms encourage traders to submit larger orders. Other allocation algorithms may encourage a trader to use an electronic trading system that can monitor market activity and submit orders on behalf of the trader very quickly and without intervention. As markets and technologies available to traders evolve, the allocation algorithms used by trading hosts must also evolve accordingly to enhance liquidity and price discovery in markets, while maintaining a fair and equitable market.

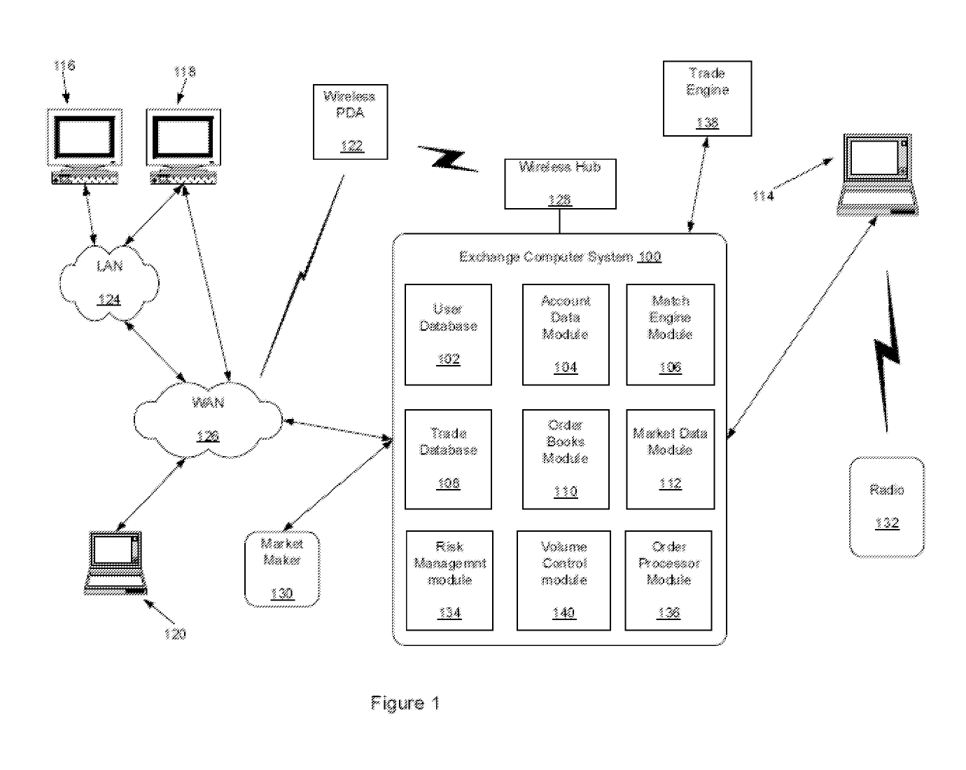

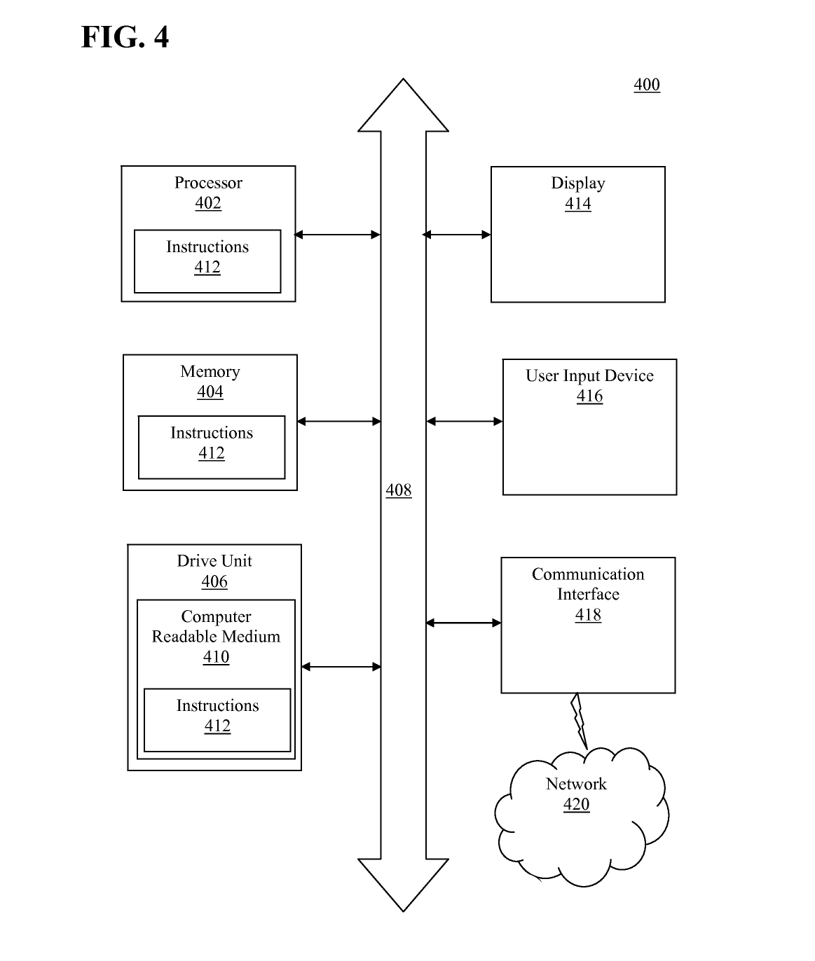

In accordance with aspects of the disclosure, systems and methods are disclosed for allocating incoming orders to resting orders which dynamically adapt, in a defined manner, to changing market conditions. The disclosed embodiments are preferably implemented with computer devices and computer networks, such as those described with respect FIG. 4, that allow users, e.g. market participants or traders, to exchange trading information. It will be appreciated that the plurality of entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange. An exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as will be described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

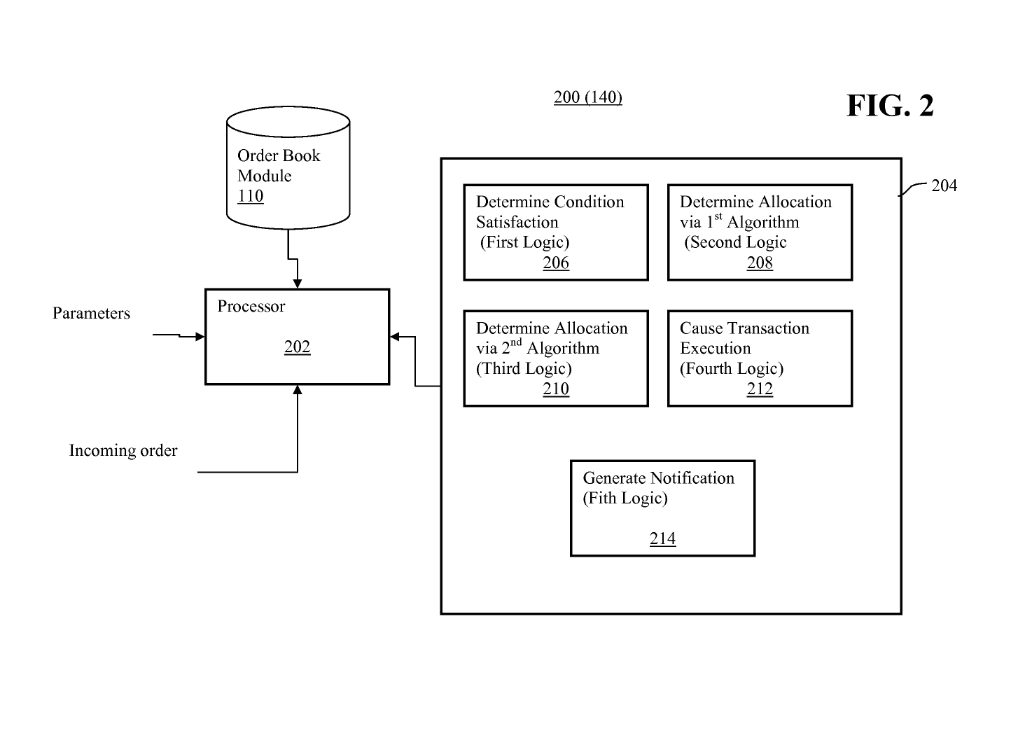

The exchange computer system 100 may be implemented with one or more mainframe, desktop or other computers, such as the computer 400 described below with respect to FIG. 4. A user database 102 may be provided which includes information identifying traders and other users of exchange computer system 100, such as account numbers or identifiers, user names and passwords. An account data module 104 may be provided which may process account information that may be used during trades. A match engine module 106 may be included to match bid and offer prices and may be implemented with software that executes one or more algorithms for matching bids and offers as will be described in more detail below with respect to FIG. 2. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by the order book module 110 and/or match engine module 106. A volume control module 140 may be included to, among other things, control the rate of acceptance of mass quote messages in accordance with one or more aspects of the disclosed embodiments. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122 which depict different exemplary methods or media by which a computer device may be coupled with the exchange computer system 100 or by which a user may communicate, e.g. send and receive, trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based computer device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

As was described above, the users of the exchange computer system 100 may include one or more market makers 130 which may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

FIG. 2 depicts a block diagram of a consolidated feed module 140 according to one embodiment, which in an exemplary implementation, is implemented as part of the exchange computer system 100 described above. As used herein, an exchange 100 includes a place or system that receives and/or executes orders.

FIG. 2 shows a system 200 for matching, or otherwise allocating, a first, e.g. incoming, order to trade a first financial product with one or more of a set of previously received unmatched orders, i.e. resting, for the first product which are counter thereto, e.g. at the same or better price than the first order. In one embodiment, the first financial product is a derivative product such as a futures contract or option contract on a futures contract. Alternatively, or in addition thereto, the first financial product may include a cash-market instrument, such as a swap. The system 200 includes a processor 202 and a memory 204 coupled therewith which may be implemented a processor 402 and memory 404 as described below with respect to FIG. 4. The system 200 further includes first logic 206 stored in the memory 204 and executable by the processor 202 to cause the processor 202 to determine whether a condition is satisfied. In one embodiment, the first logic 206 is further executable by the processor 202 to cause the processor 202 to determine whether the condition is satisfied prior to commencement of a trading session, e.g. after trading has closed or prior to the commencement of trading. It will be appreciated that the condition may be evaluated at other times, such as prior or subsequent to the receipt of an incoming order. The frequency with which the condition is evaluated and the matching algorithm thereby changed may be implementation dependent.

In one embodiment, wherein the first financial product comprises a futures contract characterized by an expiration and an underlying deliverable, the condition may include a deviation of a value of a parameter from a threshold value. In particular, the parameter may comprise a time remaining until expiration of the contract, i.e. the contract expiration month, an implied volatility of the contract price based on options contracts on the first financial product, i.e. the futures of the contract month, a realized volatility of the contract price, i.e. based on the futures contract itself, an implied volatility of the price of the underlying deliverable of the contract based on options contracts on the underlying deliverable, a realized volatility of the price of the underlying deliverable of the contract, an average daily trading volume of the contract, a measure of open interest of the contract, a difference between the price of the best resting order to sell the contract and the price of the best resting order to buy the contract, i.e. the Bid-Ask spread of the contract expiration month, a size of one or more resting orders in an order book for the financial product, a size of one or more resting orders at the top of the order book, i.e. the resting bid and ask orders at the best price, a size of one or more resting orders at successive price levels of the order book, a number of orders in the order book, a number of orders in the order book at a particular price, such as the number of orders on the best bid and the best ask, the number of orders on the best 2 bids and best 2 asks, and the number of orders five-deep (5 best bids and 5 best offers), a speed, e.g. average speed, of the match engine with respect to the first financial product, a market makeup (e.g. the member/non-member status of the entities which submitted or are submitting orders, or other categorizations of the entities submitting orders such as any regulatory, or other, classification of the entities), a rate of change of any of the aforementioned parameters, a relationship there between any of the aforementioned parameters, or combination thereof. It will be appreciated that the condition and the parameters defining the satisfaction thereof, may be defined by the Exchange, the market participants or a combination thereof.

The system 200 further includes second logic 208 stored in the memory 204 and executable by the processor 202 to cause the processor 202 to determine, according to a first matching algorithm if the condition is not satisfied, a first subset of orders of the set of previously received orders which at least partially satisfy the first order;

The system 200 further includes third logic 210 stored in the memory 204 and executable by the processor 202 to cause the processor 202 to determine, according to a second matching algorithm, different from the first matching algorithm, if the condition is satisfied, a second subset of orders of the set of previously received orders which at least partially satisfy the first order; and

The system 200 further includes fourth logic 212 stored in the memory 204 and executable by the processor 202 to cause the processor 202 to cause, subsequent to the determining, a transaction to be executed between the first order and the determined first or second subset of orders.

In one embodiment, the system 200 may further include fifth logic 214 stored in the memory 204 and executable by the processor 202 to cause the processor 202 to generate a notification to market participants when the condition is satisfied. For example, traders may receive notification via a market data feed or by other communications medium such as email.

It will be appreciated that the disclosed system 200 may switch among more than one algorithm based on more than one condition and that the system 200 may further switch back and forth among algorithms as market conditions change. Alternatively, or in addition thereto, the rate at which system 200 may switch matching algorithms may be static or may vary. For example, the system 200 may determine to change the matching algorithm for the next day's trading based on the prior day's parameters and may make the switch during non-trading hours. As another example, system 200 may determine to change the matching algorithm dynamically intra-day at any given measurement of time (e.g. every millisecond) based on any parameter's real-time value. It will be appreciated that the rate at which the subject parameters are evaluated and/or the matching algorithm is changed, as well as the variability thereof, may be implementation dependent.

In one embodiment, the first and second matching algorithms may each comprise a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

For example, wherein the condition comprises a trading volume below a threshold trading volume, the second matching algorithm may be operative to incentivize increased trading volume, such as by generating additional liquidity or via encouragement of traders to place orders. For example, the second matching algorithm may be a pro-rata algorithm. A pro rata algorithm may, in the case of a low volatility instrument, prevent favoring the first participant to place an order. Generally, pro rata matching algorithms encourage broader participation by market participants when there are fewer price movements. Further, the first matching algorithm may be a FIFO algorithm. While FIFO algorithms generally favor the first to place an order at a given price, for a high volatility instrument prices are frequently moving and therefore everyone gets frequent opportunities to be first.

In another example, the first financial product may be a futures contract characterized by an expiration and an underlying deliverable, the condition comprises a time remaining to the expiration being less than a threshold proximity, the second matching algorithm being operative to incentivize increased trading volume, such as by generating additional liquidity or via encouragement of traders to place orders. For example, the second matching algorithm may be a pro-rata algorithm. A pro rata algorithm may, in the case of a low volatility instrument, prevent favoring the first participant to place an order. Generally, pro rata matching algorithms encourage participation. Further, the first matching algorithm may be a FIFO algorithm. While FIFO algorithms generally favor the first to place an order at a given price, for a high volatility instrument prices are frequently moving and therefore everyone gets an opportunity to be first.

In the case of the system 200 being implemented in conjunction with a stock exchange, the condition may be based on changing levels of volatility of a stock due to market conditions/expectations, as opposed to time to expiry, wherein the matching algorithm is changed based thereon.

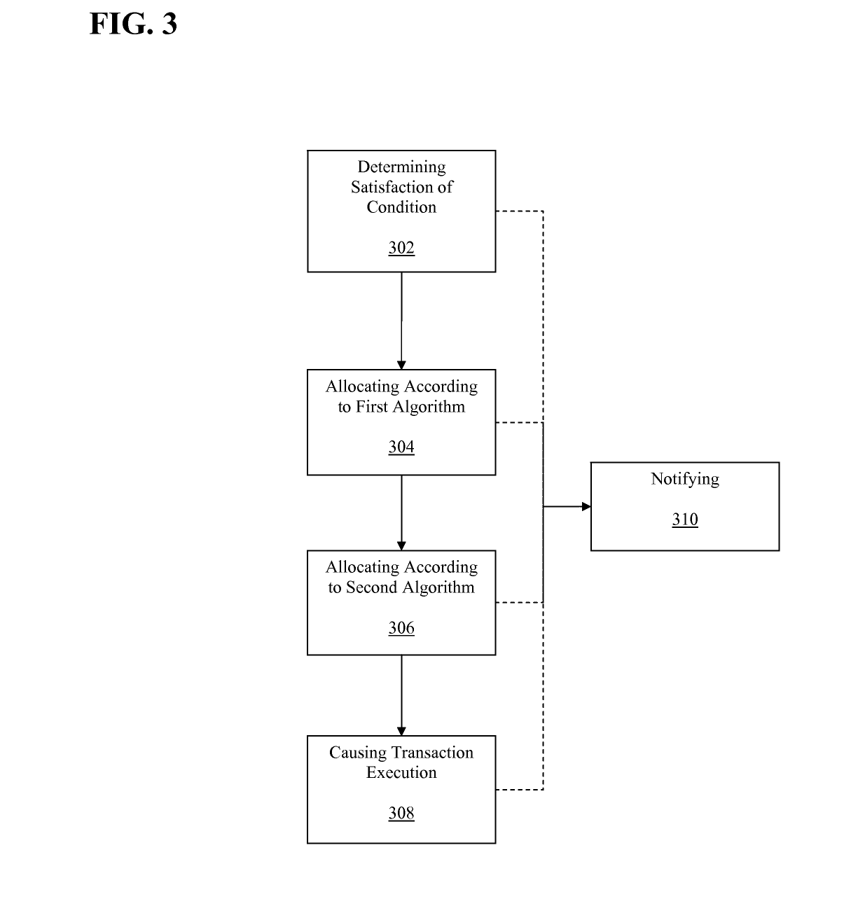

FIG. 3 depicts a flow chart showing operation of the system 200 of FIG. 2. In particular FIG. 3 shows a computer implemented method for matching, or otherwise allocating, a first, e.g. incoming, order to trade a first financial product with one or more of a set of previously received unmatched orders, i.e. resting, for the first product which are counter thereto, e.g. at the same or better price than the first order. In one embodiment, the first financial product is a derivative product such as a futures contract or option contract on a futures contract. Alternatively, or in addition thereto, the first financial product may include a cash-market instrument, such as a swap.

The operation includes: determining, by the processor 202, whether a condition is satisfied, such as prior to commencement of a trading session or subsequent or prior to receipt of an incoming order [Block 302]. The frequency with which the condition is evaluated and the matching algorithm thereby changed may be implementation dependent. In one embodiment, wherein the first financial product comprises a futures contract characterized by an expiration and an underlying deliverable, the condition may include a deviation of a value of a parameter from a threshold value. In particular, the parameter may comprise a time remaining until expiration of the contract, i.e. the contract expiration month, an implied volatility of the contract price based on options contracts on the first financial product, i.e. the futures of the contract month, a realized volatility of the contract price, i.e. based on the futures contract itself, an implied volatility of the price of the underlying deliverable of the contract based on options contracts on the underlying deliverable, a realized volatility of the price of the underlying deliverable of the contract, an average daily trading volume of the contract, a measure of open interest of the contract, a difference between the price of the best resting order to sell the contract and the price of the best resting order to buy the contract, i.e. the Bid-Ask spread of the contract expiration month, a size of one or more resting orders in an order book for the financial product, a size of one or more resting orders at the top of the order book, i.e. the resting bid and ask orders at the best price, a size of one or more resting orders at successive price levels of the order book, a number of orders in the order book, a number of orders in the order book at a particular price, such as the number of orders on the best bid and the best ask, the number of orders on the best 2 bids and best 2 asks, and the number of orders five-deep (5 best bids and 5 best offers), a speed, e.g. average speed, of the match engine with respect to the first financial product, a market makeup (e.g. the member/non-member status of the entities which submitted or are submitting orders, or other categorizations of the entities submitting orders such as any regulatory, or other, classification of the entities), a rate of change of any of the aforementioned parameters, a relationship there between any of the aforementioned parameters, or combination thereof. It will be appreciated that the condition and the parameters defining the satisfaction thereof, may be defined by the Exchange, the market participants or a combination thereof.

The operation of the system 200 further includes determining, by the processor 202 according to a first matching algorithm if the condition is not satisfied, a first subset of orders of the set of previously received orders which at least partially satisfy the first order [Block 304]; determining, by the processor 202 according to a second matching algorithm, different from the first matching algorithm, if the condition is satisfied, a second subset of orders of the set of previously received orders which at least partially satisfy the first order [Block 306]; and causing, by the processor 202 subsequent to the determining, a transaction to be executed between the first order and the determined first or second subset of orders [Block 308].

In one embodiment, the operation of the system 200 may further include notifying, by the processor 202, market participants when the condition is satisfied, such as via a market data feed or other medium [Block 310].

It will be appreciated that the disclosed system 200 may switch among more than one algorithm based on more than one condition and that the system 200 may further switch back and forth among algorithms as market conditions change.

In one embodiment, the first and second matching algorithms may each comprise a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

For example, wherein the condition comprises a trading volume below a threshold trading volume, the second matching algorithm may be operative to incentivize increased trading volume, such as by generating additional liquidity or via encouragement of traders to place orders. For example, the second matching algorithm may be a pro-rata algorithm. A pro rata algorithm may, in the case of a low volatility instrument, prevent favoring the first participant to place an order. Generally, pro rata matching algorithms encourage broader participation by market participants. Further, the first matching algorithm may be a FIFO algorithm. While FIFO algorithms generally favor the first to place an order at a given price, for a high volatility instrument prices are frequently moving and therefore everyone gets frequent opportunities to be first.

In another example, the first financial product may be a futures contract characterized by an expiration and an underlying deliverable, the condition comprises a time remaining to the expiration being less than a threshold proximity, the second matching algorithm being operative to incentivize increased trading volume, such as by generating additional liquidity or via encouragement of traders to place orders. For example, the second matching algorithm may be a pro-rata algorithm. A pro rata algorithm may, in the case of a low volatility instrument, prevent favoring the first participant to place an order. Generally, pro rata matching algorithms encourage broader participation. Further, the first matching algorithm may be a FIFO algorithm. While FIFO algorithms generally favor the first to place an order at a given price, for a high volatility instrument prices are frequently moving and therefore everyone gets frequent opportunities to be first.

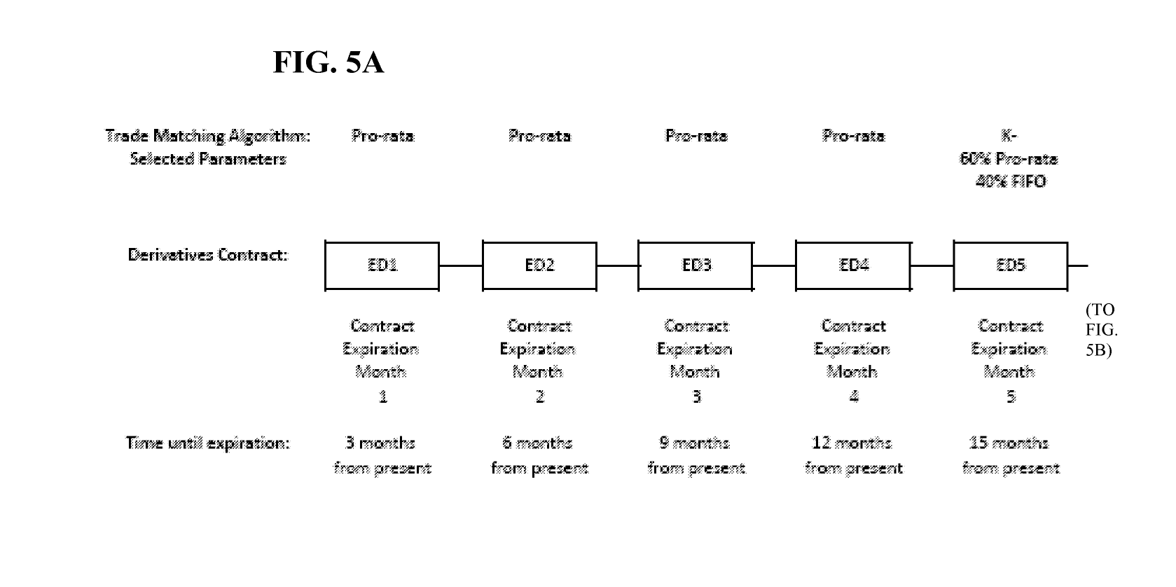

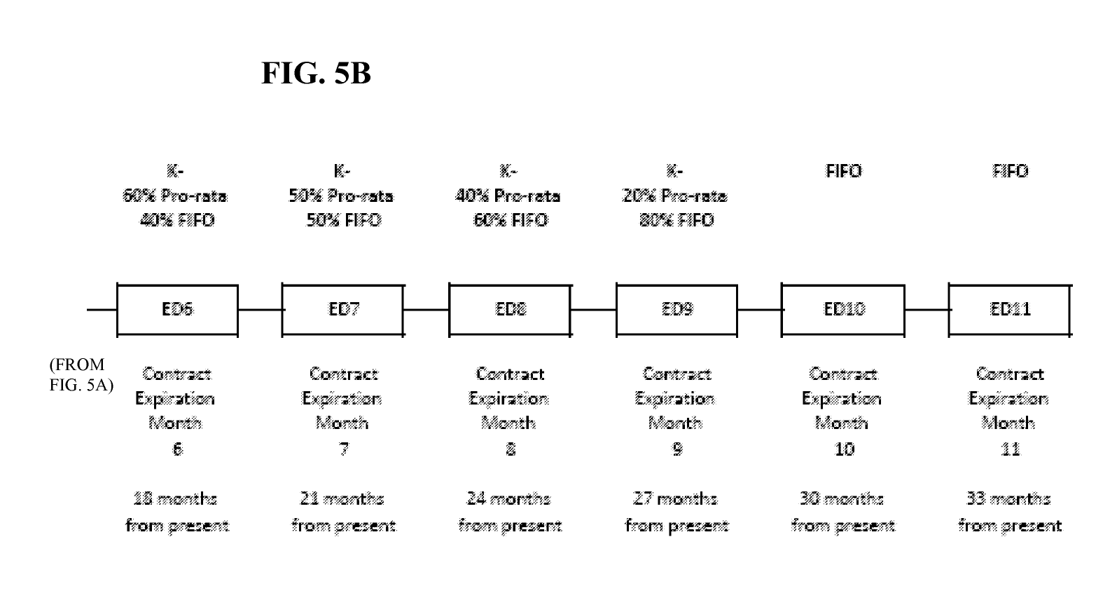

FIGS. 5A-5B depicts general application of the system of FIG. 2 based on time to contract expiration, according to one embodiment. As shown in FIGS. 5A and 5B, as time remaining to expiration decreases (shown right to left), e.g. from 30 months remaining to 27 months remaining, the matching algorithm applied to orders is switched from FIFO to a hybrid FIFO/pro rata algorithm. As the time remaining to expiration further decreases, e.g. from 15 months to 12 months, the matching algorithm is switched from the hybrid FIFO/pro rata algorithm to a pure pro-rata algorithm which is then applied for the remaining life of the contract. It will be appreciated that, as was described above, there may be no theoretical limit on how many different trade matching algorithms can be assigned within each derivative product. In practice, for each derivative product, the maximum number of trade matching algorithms that can be assigned may be limited to the number of unique contract month expirations at any given point in time. For any contract month expiration (or any other instrument for that matter), the matching algorithm may be changed at any frequency, e.g. daily, every second, every millisecond, etc., and that the rate may vary, e.g. based on market conditions. For example, when order volume is high, rate at which the matching algorithm is varied may be high, etc.

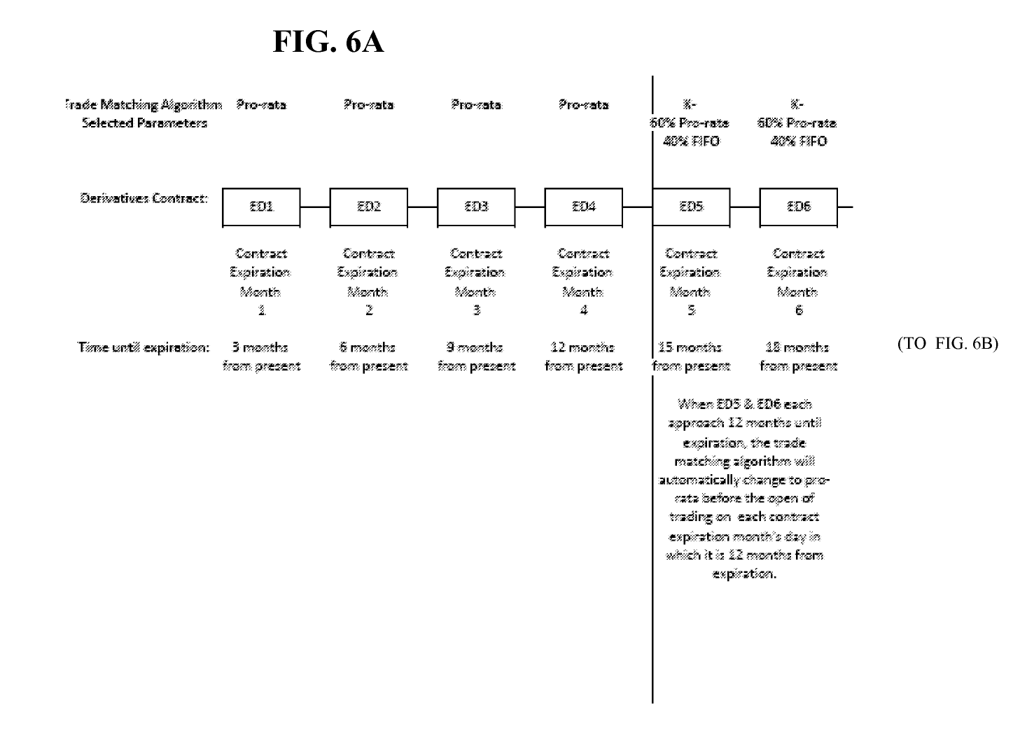

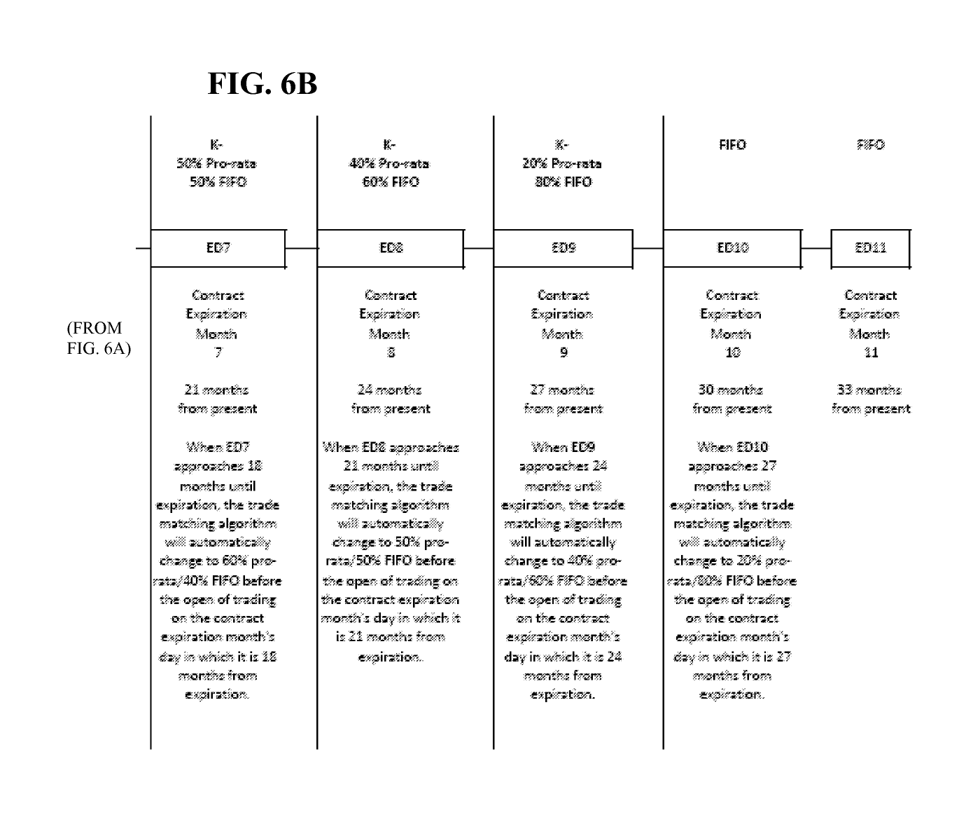

FIGS. 6A-6B depict an alternate application of the system of FIG. 2 based on time to contract expiration, according to one embodiment. As shown in FIGS. 6A and 6B, the matching algorithm is changed based on time remaining to expiration similar to the example shown in FIGS. 5A and 5B. However, in the example of FIGS. 6A and 6B, several variations of the hybrid FIFO/pro rata are applied as the time to expiration decreases wherein the applicability of the FIFO or pro rata algorithms within a given order is varied from 20% of the quantity of the order being subject to a pro rata allocation and 80% being subject to a FIFO allocation, to 60% pro rata/40% FIFO.

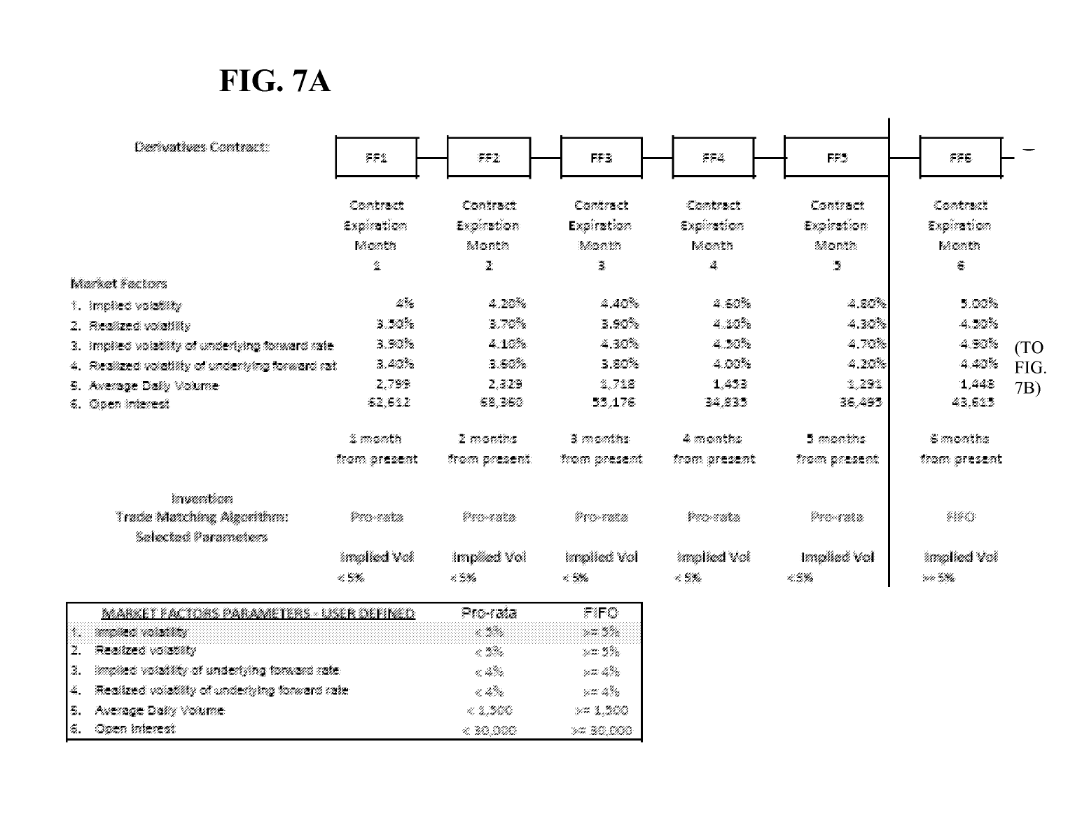

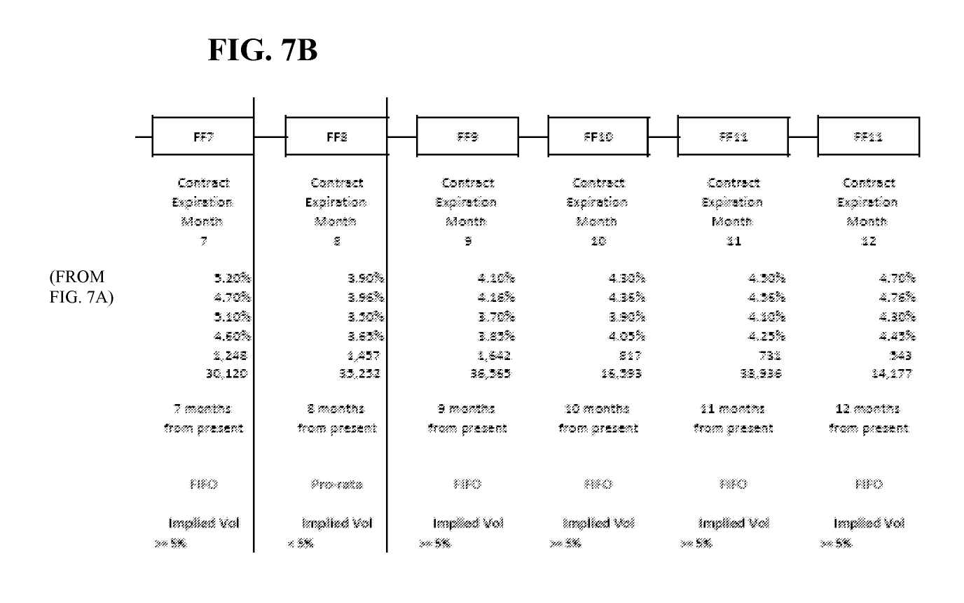

FIGS. 7A-7B depict an alternate application of the system of FIG. 2 based on various market factors, according to one embodiment. The example of FIGS. 7A-7B further demonstrates that the matching algorithm may be switched back to a previously used algorithm when conditions warrant.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

1. A computer implemented method for matching a first order to trade a first financial product with one or more of a set of previously received unmatched orders for the first product which are counter thereto, the method comprising:
determining, by the processor, whether a condition is satisfied;
determining, by the processor according to a first matching algorithm if the condition is not satisfied, a first subset of orders of the set of previously received orders which at least partially satisfy the first order;
determining, by the processor according to a second matching algorithm, different from the first matching algorithm, if the condition is satisfied, a second subset of orders of the set of previously received orders which at least partially satisfy the first order; and
causing, by the processor subsequent to the determining, a transaction to be executed between the first order and the determined first or second subset of orders.

2. The computer implemented method of claim 1 wherein the first financial product comprises a derivative product.

3. The computer implemented method of claim 1 wherein the determination as to whether the condition is satisfied is performed prior to commencement of a trading session.

4. The computer implemented method of claim 1 wherein the first financial product comprises a futures contract characterized by an expiration and an underlying deliverable, the condition comprising a deviation of a value of a parameter from a threshold value, wherein the parameter comprises a time remaining until expiration, an implied volatility of the contract price based on options contracts on the first financial product, a realized volatility of the contract price, an implied volatility of the price of the underlying deliverable of the contract based on options contracts on the underlying deliverable, a realized volatility of the price of the underlying deliverable of the contract, an average daily trading volume of the contract, a measure of open interest of the contract, a difference between the price of the best resting order to sell the contract and the price of the best resting order to buy the contract, a size of one or more resting orders in an order book for the financial product, a size of one or more resting orders at the top of the order book, a size of one or more resting orders at successive price levels of the order book, a number of orders in the order book, a number of orders in the order book at a particular price, a speed of the match engine with respect to the first financial product, a market makeup, rate of change thereof, relationship there between, or combination thereof.

5. The computer implemented method of claim 1 wherein the condition is defined by a market participant, the Exchange, or a combination thereof.

6. The computer implemented method of claim 1 wherein the first and second matching algorithms each comprise a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

7. The computer implemented method of claim 1, wherein the condition comprises a trading volume below a threshold trading volume, the second matching algorithm being operative to incentivize increased trading volume.

8. The computer implemented method of claim 7 wherein the second matching algorithm comprises a pro-rata algorithm.

9. The computer implemented method of claim 7 wherein the first matching algorithm comprises FIFO algorithm.

10. The computer implemented method of claim 1, wherein the first financial product comprises a futures contract characterized by an expiration and an underlying deliverable, the condition comprises a time remaining to the expiration being less than a threshold proximity, the second matching algorithm being operative to incentivize increased trading volume.

11. The computer implemented method of claim 10 wherein the second matching algorithm comprises a pro-rata algorithm.

12. The computer implemented method of claim 10 wherein the first matching algorithm comprises FIFO algorithm.

13. The computer implemented method of claim 1 further comprising notifying, by the processor, market participants when the condition is satisfied.

14. A system for matching a first order to trade a first financial product with one or more of a set of previously received unmatched orders for the first product which are counter thereto, the system comprising:
a processor;
a memory coupled with the processor;
first logic stored in the memory and executable by the processor to cause the processor to determine whether a condition is satisfied;
second logic stored in the memory and executable by the processor to cause the processor to determine, according to a first matching algorithm if the condition is not satisfied, a first subset of orders of the set of previously received orders which at least partially satisfy the first order;
third logic stored in the memory and executable by the processor to cause the processor to determine, according to a second matching algorithm, different from the first matching algorithm, if the condition is satisfied, a second subset of orders of the set of previously received orders which at least partially satisfy the first order; and
fourth logic stored in the memory and executable by the processor to cause the processor to cause, subsequent to the determining, a transaction to be executed between the first order and the determined first or second subset of orders.

15. The system of claim 14 wherein the first financial product comprises a derivative product.

16. The system of claim 14 wherein the first logic is further executable by the processor to cause the processor to determine whether the condition is satisfied prior to commencement of a trading session.

17. The system of claim 14 wherein the first financial product comprises a futures contract characterized by an expiration and an underlying deliverable, the condition comprising a deviation of a value of a parameter from a threshold value, wherein the parameter comprises a time remaining until expiration, an implied volatility of the contract price based on options contracts on the first financial product, a realized volatility of the contract price, an implied volatility of the price of the underlying deliverable of the contract based on options contracts on the underlying deliverable, a realized volatility of the price of the underlying deliverable of the contract, an average daily trading volume of the contract, a measure of open interest of the contract, a difference between the price of the best resting order to sell the contract and the price of the best resting order to buy the contract, a size of one or more resting orders in an order book for the financial product, a size of one or more resting orders at the top of the order book, a size of one or more resting orders at successive price levels of the order book, a number of orders in the order book, a number of orders in the order book at a particular price, a speed of the match engine with respect to the first financial product, a market makeup, rate of change thereof, relationship there between, or combination thereof.

18. The system of claim 14 wherein the condition is defined by a market participant, the Exchange, or a combination thereof.

19. The system of claim 14 wherein the first and second matching algorithms each comprise a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

20. The system of claim 14, wherein the condition comprises a trading volume below a threshold trading volume, the second matching algorithm being operative to incentivize increased trading volume.

21. The system of claim 20 wherein the second matching algorithm comprises a pro-rata algorithm.

22. The system of claim 20 wherein the first matching algorithm comprises FIFO algorithm.

23. The system of claim 14, wherein the first financial product comprises a futures contract characterized by an expiration and an underlying deliverable, the condition comprises a time remaining to the expiration being less than a threshold proximity, the second matching algorithm being operative to incentivize increased trading volume.

24. The system of claim 23 wherein the second matching algorithm comprises a pro-rata algorithm.

25. The system of claim 23 wherein the first matching algorithm comprises FIFO algorithm.

26. The system of claim 14 further comprising fifth logic stored in the memory and executable by the processor to cause the processor to generate a notification to market participants when the condition is satisfied.

27. A computer implemented method for allocating a first incoming order to trade a first financial product with one or more of a first set of previously received unmatched orders for the first financial product which are counter thereto and for allocating a second incoming order to trade the first financial product with one or more of a second set of previously received unmatched orders for the first financial product which are counter thereto, the method comprising:
evaluating, by a processor, a market parameter and based on the market parameter meeting a first condition, determining a first allocation algorithm of a plurality of allocation algorithms to be used to allocate the first incoming order for the first financial product to the one or more of the first set of previously received unmatched orders for the first financial product which are counter thereto;
causing, by the processor, allocation of the first incoming order in accordance with the determined first allocation algorithm;
evaluating, by the processor, the market parameter and based on the market parameter meeting a second condition different from the first condition, determining a second allocation algorithm of a plurality of allocation algorithms, the second allocation algorithm being different than the first allocation algorithm, to be used to allocate the second incoming order for the first financial product to the one or more of the second set of previously received unmatched orders for the first financial product which are counter thereto; and
causing, by the processor, allocation of the second incoming order in accordance with the determined second allocation algorithm.

28. A system for matching a first order to trade a first financial product with one or more of a set of previously received unmatched orders for the first product which are counter thereto, the system comprising:
means for determining whether a condition is satisfied;
means for determining, according to a first matching algorithm if the condition is not satisfied, a first subset of orders of the set of previously received orders which at least partially satisfy the first order;
means for determining, according to a second matching algorithm, different from the first matching algorithm, if the condition is satisfied, a second subset of orders of the set of previously received orders which at least partially satisfy the first order; and
means for causing, subsequent to the determining, a transaction to be executed between the first order and the determined first or second subset of orders.
